(19) United States
(12) Patent Application Publication
(10) Pub. No.: US 2026/0180130 A1
(43) Pub. Date: Jun. 25, 2026

(54) SEPARATOR FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Bae Wook LEE, Suwon-si (KR); Jung Seong LEE, Suwon-si (KR); Nam Ju KIM, Suwon-si (KR)

(73) Assignee: SAMSUNG SDI CO., LTD., Yongin-si (KR)

(21) Appl. No.: 19/427,709

(22) Filed: Dec. 19, 2025

(30) Foreign Application Priority Data
Dec. 24, 2024 (KR) 10-2024-0195895

(51) Int. Cl. H01M 50/457; H01M 50/42; H01M 50/426; H01M 50/446

(52) U.S. Cl. CPC H01M 50/457; H01M 50/42; H01M 50/426; H01M 50/446

(57) ABSTRACT

The present disclosure relates to a separator for a rechargeable lithium battery, and a rechargeable lithium battery including the separator. The separator includes a porous substrate, and a first layer and a second layer sequentially located on at least one surface of the porous substrate. The second layer includes a mixture of a polyvinylidene fluoride (PVdF)-based adhesive binder and a (meth)acryl-based adhesive binder, and the (meth)acryl-based adhesive binder is a copolymer of a monomer mixture including a (meth)acryl-based monomer having a cyano group and a (meth)acryl-based monomer having an alkyl group.

### CROSS-REFERENCE TO RELATED APPLICATION

The present application claims priority to Korean Patent Application No. 10-2024-0195895, filed on Dec. 24, 2024, in the Korean Intellectual Property Office, the entire disclosure of which is incorporated herein by reference.

### BACKGROUND

### 1. Field of the Disclosure

The present disclosure relates to a separator for a rechargeable lithium battery, and a rechargeable lithium battery including the separator.

### 2. Discussion of Related Art

With increasing presence of electronic devices such as, e.g., mobile phones, notebook computers, electric vehicles, and the like, that use batteries, the demand for secondary batteries having high energy density and high capacity is increasing. Therefore, improving the performance of rechargeable lithium batteries may be advantageous.

A rechargeable lithium battery typically includes a positive electrode and a negative electrode that contain an active material capable of the intercalation and deintercalation of lithium ions, and produces electric energy by oxidation and reduction reactions when the lithium ions are intercalated into and deintercalated from the positive electrode and the negative electrode.

The rechargeable lithium battery may include a separator between the positive electrode and the negative electrode. The separator is impregnated in an electrolyte solution.

### SUMMARY

One example embodiment includes a rechargeable lithium battery separator having high substrate adhesion, a low heat shrinkage rate, and high puncture strength.

Another example embodiment includes a rechargeable lithium battery including a separator for a rechargeable lithium battery.

According to one example embodiment, there is provided a separator for a rechargeable lithium battery.

The separator for a rechargeable lithium battery includes a porous substrate, and a first layer and a second layer located, e.g., sequentially located, on at least one surface of the porous substrate. The second layer includes a mixture of a polyvinylidene fluoride (PVdF)-based adhesive binder and a (meth)acryl-based adhesive binder. The (meth)acryl-based adhesive binder is or includes a copolymer of a monomer mixture including a (meth)acryl-based monomer having a cyano group (—CN) and a (meth)acryl-based monomer having an alkyl group.

According to another example embodiment, a rechargeable lithium battery includes the separator for a rechargeable lithium battery, a positive electrode, and a negative electrode.

### BRIEF DESCRIPTION OF THE DRAWINGS

The following drawings attached to the present specification illustrate example embodiments of the present disclosure and further describe aspects and features of the present disclosure together with the detailed description of the present disclosure. Thus, the present disclosure should not be construed as being limited to the drawings, in which:

FIG. 1 is a cross-sectional view showing a separator for a rechargeable lithium battery according to one example embodiment; and

FIG. 2 to FIG. 5 are schematic cross-sectional views showing a rechargeable lithium battery according to one example embodiment.

### DETAILED DESCRIPTION

Hereinafter, example embodiments of the present disclosure are described in detail. However, the example embodiments are provided as examples, the present disclosure is not limited thereto, and the present disclosure is only defined by the scope of the claims to be described below.

Unless otherwise specified herein, when a part such as a layer, film, region, plate, and the like, is described as being “on” another part, it includes not only the case where the part is “directly on” the other part, but also the case where there is at least another part therebetween.

Unless otherwise specified in this specification, any feature or element indicated in the singular may also include the plural. Further, unless otherwise stated, “A or B” may mean “including A, including B, or including A and B.”

As used herein, the term “a combination thereof” may mean a mixture, laminate, composite, copolymer, alloy, blend, and reaction product of the components.

Here, the term “particle diameter D100” refers to the average particle diameter, which means the diameter of particles with a cumulative volume of 100% by volume in the particle size distribution. The particle size distribution may be measured by methods known to those skilled in the art. For example, the particle size distribution may be measured using a particle size analyzer, a transmission electron micrograph, or a scanning electron micrograph. In another method, an D100 value may be obtained by measuring the particle diameter using a measuring device using dynamic light scattering, performing data analysis to count the number of particles for each particle size range, and then calculating the particle diameter therefrom. Alternatively, D100 may be measured using a laser diffraction method. For example, when measuring by laser diffraction, after the particles to be measured are dispersed in a dispersion medium, the particles may be introduced into a commercially available laser diffraction particle diameter measuring device (e.g., Microtrac MT 3000) and irradiated with ultrasonic waves of about 28 kHz at an output of 60 W, and the D100 based on the cumulative volume of 100% by volume of the particle size distribution in the measurement device may be calculated.

In this specification, ‘particle diameter D50’ refers to the particle diameter of a particle having a cumulative volume of 50% by volume in a particle size distribution. The particle size distribution can be obtained by referring to the method described in the above ‘particle diameter D100’.

In this specification, “(meth)acrylic” means acrylic and/or methacrylic.

Unless otherwise defined herein, “substitution” means that hydrogen in a compound is replaced by a substituent such as or including at least one of a C1 to C30 alkyl group, a C2 to C30 alkenyl group, a C2 to C30 alkynyl group, a C6 to C30 aryl group, a C7 to C30 alkylaryl group, a C1 to C30 alkoxy group, a C1 to C30 heteroalkyl group, a C3 to C30 heteroalkylaryl group, a C3 to C30 cycloalkyl group, a C3 to C15 cycloalkenyl group, a C6 to C30 cycloalkynyl group, a C2 to C30 heterocycloalkyl group, a halogen (F, Cl, Br or I), a hydroxyl group (—OH), a nitro group (—NO₂), a cyano group (—CN), an amino group (—NRR′) (wherein, R and R′ are each independently hydrogen or a C1 to C6 alkyl group), a sulfobetaine group (—RR′N⁺(CH₂)ₙSO₃⁻, n is a natural number from 1 to 10), a carboxybetaine group (—RR′N⁺(CH₂)ₙCOO⁻, n is a natural number from 1 to 10) (wherein, R and R′ are each independently a C1 to C20 alkyl group), an azido group (—N₃), an amidino group (—C(═NH)NH₂), a hydrazino group (—NHNH₂), a hydrazono group (═N(NH₂), a carbamoyl group (—C(═O)NH₂), a thiol group (—SH), an acyl group (—C(═O)R, where R is hydrogen, a C1 to C6 alkyl group, a C1 to C6 alkoxy group, or a C6 to C12 aryl group), a carboxyl group (—COOH) or a salt thereof (—C(═O)OM, where M is an organic or inorganic cation), a sulfonic acid group (—SO₃H) or a salt thereof (—SO₃M, where M is an organic or inorganic cation), a phosphate group (—PO₃H₂) or a salt thereof (—PO₃MH or —PO₃M₂, where M is an organic or inorganic cation), and combinations thereof.

Hereinafter, a C1 to C3 alkyl group means a methyl group, an ethyl group, or a propyl group. A C1 to C10 alkylene group may be or include, for example, a C1 to C6 alkylene group, a C1 to C5 alkylene group, or a C1 to C3 alkylene group, such as a methylene group, an ethylene group, or a propylene group. A C3 to C20 cycloalkylene group may be or include, for example, a C3 to C10 cycloalkylene group or a C5 to C10 cycloalkylene group, such as a cyclohexylene group. A C6 to C20 arylene group may be or include, for example, a C6 to C10 arylene group, such as a phenylene group. A C3 to C20 heterocyclic group may be or include, for example, a C3 to C10 heterocyclic group, such as a pyridine group.

Hereinafter, “hetero” means including one or more heteroatoms such as or including at least one of N, O, S, Si, and P.

In chemical formulas, the * symbol indicates a moiety that is connected to the same or different atoms, groups, or structural units.

Unless otherwise specifically stated in the chemical formulas described herein, it may be assumed that hydrogen is bonded in the structure of the chemical formula.

Hereinafter, “alkali metal” refers to an element belonging to Group 1 of the periodic table, such as lithium, sodium, potassium, rubidium, cesium, or francium and may be present in a cationic or neutral state.

When describing a numerical range in this specification, ‘X to Y’ means ‘X or more and Y or less (X≤ and ≤Y).’

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

According to one example embodiment, the separator for a rechargeable battery of the present disclosure can exhibit high substrate adhesion, a low thermal shrinkage rate, and high puncture strength.

For example, the separator may have substrate adhesion of about 1.0 N/12 mm or more. The substrate adhesion may represent interfacial adhesion between the first layer and the second layer of the separator.

For example, the separator may have a heat shrinkage rate of about 3.5% or less, and about 1.2% or less, measured in each of a machine direction (MD) and a transverse direction (TD). Here, the machine direction may be a machine direction of the porous substrate of the separator, and the transverse direction may be substantially the same direction as the transverse direction of the porous substrate of the separator.

For example, the separator may have a puncture strength of about 340 gf or more.

The separator includes a porous substrate, and a first layer and a second layer located, e.g., sequentially located on at least one surface of the porous substrate, in which the second layer includes a mixture of a polyvinylidene fluoride (PVdF)-based adhesive binder and a (meth)acryl-based adhesive binder, in which the (meth)acryl-based adhesive binder is a copolymer of a monomer mixture including a (meth)acryl-based monomer having a cyano group (—CN) and a (meth)acryl-based monomer having an alkyl group.

Since the (meth)acryl-based adhesive binder increases adhesion between the PVdF-based adhesive binder and the first layer, the separator can provide high substrate adhesion, a low heat shrinkage rate, and high puncture strength. As is described below, the first layer includes an aqueous binder, and the second layer, particularly, the PVdF-based adhesive binder, is an organic-based adhesive binder. The (meth)acryl-based monomer having a cyano group and the (meth)acryl-based monomer having an alkyl group have desired or improved adhesion to both the second layer, which is an organic coating layer, and the first layer, which is an aqueous coating layer, and thus can be advantageous in providing high substrate adhesion of the separator.

The (meth)acryl-based adhesive binder can be readily distributed with a concentration gradient of the second layer during the process of forming the second layer, which is described below, thereby further increasing the substrate adhesion of the separator. That is, the second layer is formed of or include a composition including a PVdF-based adhesive binder and a (meth)acryl-based adhesive binder, and by a humidifying process using ethanol, which is described below, the PVdF-based adhesive binder can move away from the first layer, and the (meth)acryl-based adhesive binder can relatively readily move toward the first layer. Accordingly, the content of the (meth)acryl-based adhesive binder of the second layer of the separator may gradually increase toward the first layer. This may allow the (meth)acryl-based adhesive binder to increase adhesion between the PVdF-based adhesive binder and the first layer.

The (meth)acryl-based adhesive binder is an amorphous binder. Accordingly, the (meth)acryl-based adhesive binder can provide an adhesive effect of the second layer. Here, the “amorphous binder” refers to an adhesive.

The (meth)acryl-based adhesive binder is a heat curable binder. Accordingly, during the process of forming the second layer, the (meth)acryl-based adhesive binder may be advantageous in increasing a puncture strength and the like of the separator through high-temperature aging.

The (meth)acryl-based adhesive binder may have a weight average molecular weight in a range of about 1 million g/mol to about 1.5 million g/mol, for example 1 million, 1.1 million, 1.2 million, 1.3 million, 1.4 million or 1.5 million g/mol. In the above range, the (meth)acryl-based adhesive binder may be advantageous in providing high substrate adhesion, a low heat shrinkage rate, and a high puncture strength. Here, the weight average molecular weight may be obtained as a standard styrene conversion value using, e.g., gel permeation chromatography.

The (meth)acryl-based adhesive binder may have a glass transition temperature in a range of about −20 to about −10° C., for example −20, −19, −18, −17, −16, −15, −14, −13, −12, −11, −10° C. In the above range, the (meth)acryl-based adhesive binder may be advantageous in providing high substrate adhesion, a low heat shrinkage rate, and a high puncture strength. Here, the glass transition temperature may be a value measured using, e.g., differential scanning calorimetry (DSC).

A monomer mixture of the (meth)acryl-based adhesive binder may include a range of about 1 mol % to about 20 mol %, for example, 1, 2, 3, 4, 5, 6, 7, 8, 9, 10, 11, 12, 13, 14, 15, 16, 17, 18, 19, 20 mol %, 5 mol % to 20 mol %, of the (meth)acryl-based monomer having a cyano group. In the above range, miscibility between the first layer and the second layer can be good, thereby increasing substrate adhesion.

The monomer mixture of the (meth)acryl-based adhesive binder may include about 80 mol % or more, for example, a range of about 80 mol % to about 99 mol %, for example 80, 81, 82, 83, 84, 85, 86, 87, 88, 89, 90, 91, 92, 93, 94, 95, 96, 97, 98, 99 mol %, or 80 mol % to 95 mol %, of the (meth)acryl-based monomer having an alkyl group. In the above range, miscibility between the first layer and the second layer can be good, thereby increasing substrate adhesion.

The (meth)acryl-based adhesive binder may be or include a copolymer of a monomer mixture including (meth)acrylonitrile as the (meth)acryl-based monomer having a cyano group, n-butyl acrylate and n-butyl methacrylate as the (meth)acryl-based monomer having an alkyl group. The adhesive binder can have good miscibility between the first layer and the second layer, thereby increasing substrate adhesion.

The (meth)acryl-based adhesive binder of the second layer and the PVdF-based adhesive binder may be included in a weight ratio in a range of about 1:10 to about 1:30. In the above range, it is possible to increase the adhesion of the second layer to a positive or negative electrode. For example, the weight ratio may be 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, or range from about 1:15 to about 1:20.

Hereinafter, the configuration of the separator according to one example embodiment is described in detail.

### First Layer

The first layer may be or include a heat-resistant layer. The first layer may include a binder and a filler.

### Binder

The binder is or includes a non-adhesive binder and has high heat resistance and thus can contribute to decreasing the heat shrinkage rate of the separator. The binder may be or include an aqueous heat-resistant binder.

The binder includes a (meth)acryl-based binder including a sulfonate group-containing structural unit. The (meth)acryl-based binder including a sulfonate group-containing structural unit can be good for improving heat resistance and reducing membrane resistance.

The sulfonate group-containing structural unit may be included in the (meth)acryl-based binder in an amount ranging from about 0.1 mol % to about 65 mol %, for example, from 0.1 mol % to about 60 mol %, from 0.1 mol % to 20 mol %, from 0.1 mol % to 10 mol %, for example, from 1 mol % to 20 mol %, for example, from 1 mol % to 10 mol %, for example, from 20 mol % to 65 mol %, or from 30 mol % to 65 mol %. When the sulfonate group-containing structural unit is included within the above range, the (meth)acryl-based binder and the separator including the (meth)acryl-based binder can exhibit desired or improved bonding strength, heat resistance, air permeability, and oxidation resistance.

The (meth)acryl-based binder may further include one or more of a structural unit derived from (meth)acrylate or (meth)acrylic acid, a cyano group-containing structural unit, and a structural unit derived from (meth)acryl amide.

The structural unit derived from (meth)acrylate or (meth)acrylic acid may be included in the (meth)acryl-based binder in an amount ranging from about 0 mol % to about 70 mol %, for example, from 10 mol % to 70 mol %, from 10 mol % to 60 mol %, from 2 mol % to 60 mol %, from 10 mol % to 50 mol %, from 30 mol % to 60 mol %, from 10 mol % to 40 mol %, or from 40 mol % to 55 mol %. When the structural unit derived from (meth)acrylate or (meth)acrylic acid is included in the above range, a separator containing the (meth)acryl-based binder can exhibit desired or improved bonding strength, heat resistance, air permeability, and oxidation resistance.

The cyano group-containing structural unit may be included in the (meth)acryl-based binder in an amount ranging from about 0 mol % to about 85 mol %, for example, from 30 mol % to 85 mol %, for example, from 30 mol % to 70 mol %, for example, from 30 mol % to 60 mol %, or for example, from 35 mol % to 55 mol %. When the cyano group-containing structural unit is included within the above range, the (meth)acryl-based binder and the separator including the (meth)acryl-based binder can secure desired or improved oxidation resistance and exhibit desired or improved bonding strength, heat resistance, and air permeability.

The structural unit derived from (meth)acrylamide may be included in the (meth)acryl-based binder in an amount ranging from about 0 mol % to about 95 mol %, for example, from 40 mol % to 85 mol %, for example, from 50 mol % to 85 mol %, from 55 mol % to 95 mol %, from 60 mol % to 85 mol %, from 75 mol % to 95 mol %, or from 80 mol % to 95 mol %. When the structural unit derived from (meth)acrylamide is included within the above range, the (meth)acryl-based binder and the separator including the (meth)acryl-based binder can secure desired or improved oxidation resistance and exhibit desired or improved bonding strength, heat resistance, and air permeability.

According to one example embodiment, the (meth)acryl-based binder may have a sulfonate group-containing structural unit, a structural unit derived from (meth)acrylate or (meth)acrylic acid, and a cyano group-containing structural unit. In one example, the total amount of the sulfonate group-containing structural unit, the structural unit derived from (meth)acrylate or (meth)acrylic acid, and the cyano group-containing structural unit may be about 95 mol % or more, for example, may range from about 95 mol % to about 100 mol %, or may be 100 mol %, among 100 mol % of the (meth)acryl-based binder.

According to another example embodiment, the (meth)acryl-based binder may have a sulfonate group-containing structural unit and a structural unit derived from (meth)acrylamide. In one example, the total amount of the sulfonate group-containing structural unit and the structural unit derived from (meth)acrylamide may be about 95 mol % or more, for example, may range from about 95 mol % to about 100 mol %, or may be 100 mol %, among 100 mol % of the (meth)acryl-based binder.

According to still another example embodiment, the (meth)acryl-based binder may have a sulfonate group-containing structural unit, a structural unit derived from (meth)acrylate or (meth)acrylic acid, and a structural unit derived from (meth)acrylamide. In one example, the total amount of the sulfonate group-containing structural unit, the structural unit derived from (meth)acrylate or (meth)acrylic acid, and the structural unit derived from (meth)acrylamide, may be about 95 mol % or more, for example, may range from about 95 mol % to about 100 mol %, or may be about 100 mol % among 100 mol % of the (meth)acryl-based binder.

Each structural unit of the (meth)acryl-based binder is described in detail.

The structural unit derived from (meth)acrylate or (meth)acrylic acid may be represented, for example, by at least one of Chemical Formula 1, 2, or 3 below, or a combination thereof:

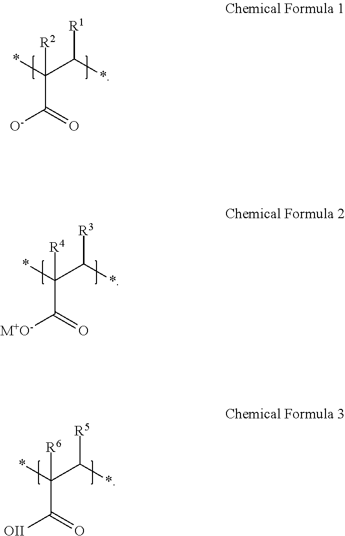

In Chemical Formulas 1 to 3,
R¹ to R⁶ each independently is or includes hydrogen or a methyl group, and
in Chemical Formula 2,
M is or includes an alkali metal.

The alkali metal may be or include, for example, at least one of lithium, sodium, potassium, rubidium, or cesium.

For example, the structural unit derived from (meth)acrylate or (meth)acrylic acid may include the structural unit represented by Chemical Formula 2 and the structural unit represented by Chemical Formula 3, and in this case, the structural unit represented by Chemical Formula 2 and the structural unit represented by Chemical Formula 3 may be included in a molar ratio in a range of about 10:1 to about 1:2, 10:1 to 1:1, or 5:1 to 1:1.

The cyano group-containing structural unit may be, for example, represented by Chemical Formula 4 below:

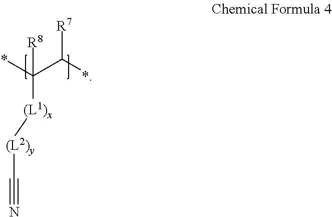

In Chemical Formula 4,
R⁷ and R⁸ each independently is or includes hydrogen or a C1 to C3 alkyl group,
L¹ is or includes —C(═O)—, —C(═O)O—, —OC(═O)—, —O—, or —C(═O)NH—,
x is an integer ranging from 0 to 2,
L² is or includes a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group, and
y is an integer ranging from 0 to 2.

The cyano group-containing structural unit may be or include, for example, a structural unit derived from (meth)acrylonitrile, an alkene nitrile, a cyanoalkyl (meth)acrylate, or a 2-(vinyloxy)alkanenitrile. Here, the alkene may be or include at least one of a C2 to C20 alkene, a C2 to C10 alkene, or a C2 to C6 alkene, the alkyl may be or include at least one of a C1 to C20 alkyl, a C1 to C10 alkyl, or a C1 to C6 alkyl, and the alkane may be or include at least one of a C1 to C20 alkane, a C1 to C10 alkane, or a C1 to C6 alkane.

The alkene nitrile may be or include, for example, at least one of allyl cyanide, 4-pentenenitrile, 3-pentenenitrile, 2-pentenenitrile, 5-hexenenitrile, and the like. The cyanoalkyl (meth)acrylate may be or include, for example, at least one of cyanomethyl (meth)acrylate, cyanoethyl (meth)acrylate, cyanopropyl (meth)acrylate, cyanooctyl (meth)acrylate, and the like. The 2-(vinyloxy)alkanenitrile may be or include, for example, at least one of 2-(vinyloxy)ethanenitrile, 2-(vinyloxy)propanenitrile, and the like.

The sulfonate group-containing structural unit may be or include a structural unit containing a conjugate base of sulfonic acid, a sulfonate salt, sulfonic acid, or a derivative thereof. For example, the sulfonate group-containing structural unit may be represented by at least one of Chemical Formula 5, 6, or 7 below, or a combination thereof:

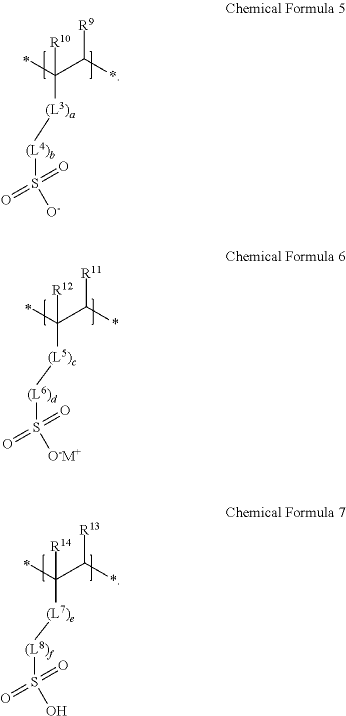

In Chemical Formulas 5 to 7,
R⁹ to R¹⁴ each independently is or includes hydrogen or a C1 to C3 alkyl group,
L³, L⁵, and L⁷ each independently is or includes —C(═O)—, —C(═O)O—, —OC(═O)—, —O—, or —C(═O)NH—,
L⁴, L⁶, and L⁸ each independently is or includes a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group,
a, b, c, d, e, and f are each independently an integer ranging from 0 to 2, and
in Chemical Formula 6,
M is or includes an alkali metal.

For example, in Chemical Formulas 5 to 7,
L³, L⁵, and L⁷ each independently is or includes —C(═O)NH—,
L⁴, L⁶, and L⁸ each independently is or includes a C1 to C10 alkylene group, and
a, b, c, d, e, and f may each be the integer 1.

The sulfonate group-containing structural unit may include only one, or two or more, of the structural unit represented by Chemical Formula 5, the structural unit represented by Chemical Formula 6, and the structural unit represented by Chemical Formula 7. As an example, the sulfonate group-containing structural unit may include the structural unit represented by Chemical Formula 6, and as another example, the sulfonate group-containing structural unit may include the structural unit represented by Chemical Formula 6 and the structural unit represented by Chemical Formula 7.

The sulfonate group-containing structural unit may be or include, for example, a structural unit derived from vinyl sulfonic acid, allyl sulfonic acid, styrene sulfonic acid, anethole sulfonic acid, a (meth)acrylamidoalkane sulfonic acid, a sulfoalkyl (meth)acrylate, or salts thereof. Here, the alkane may be or include at least one of a C1 to C20 alkane, a C1 to C10 alkane, or a C1 to C6 alkane, and the alkyl may be or include at least one of a C1 to C20 alkyl, a C1 to C10 alkyl, or a C1 to C6 alkyl. The salt is a salt composed of or including the above-described sulfonic acid and a desired ion. The ion may be, for example, an alkali metal ion, and in this case, the salt may be or include an alkali metal salt of sulfonic acid.

The (meth)acrylamidoalkane sulfonic acid may be or include, for example, 2-(meth)acrylamido-2-methylpropanesulfonic acid, and the sulfoalkyl (meth)acrylate may be or include, for example, at least one of 2-sulfoethyl (meth)acrylate, 3-sulfopropyl (meth)acrylate, and the like.

The structural unit derived from (meth)acrylamide may be represented by Chemical Formula 8 below.

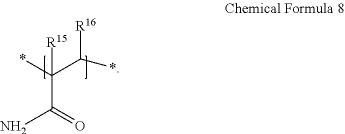

In Chemical Formula 8,

R¹⁵ and R¹⁶ each independently is or includes hydrogen or a methyl group.

The (meth)acryl-based binder may include an alkali metal. The alkali metal may be present in the form of a cation and for example, may be or include at least one of lithium, sodium, potassium, rubidium, or cesium. For example, the alkali metal may be combined with the (meth)acryl-based binder, and may be present in the form of a salt. The alkali metal may assist in the synthesis of the (meth)acryl-based binder in an aqueous solvent, increase the adhesion of the first layer, and increase the heat resistance, air permeability, oxidation resistance, and the like, of the separator.

The alkali metal may be included in an amount ranging from about 1 wt % to about 40 wt % of the alkali metal and the (meth)acryl-based binder, for example, from 1 wt % to 30 wt %, from 1 wt % to 20 wt %, or from 10 wt % to 20 wt %. For example, the (meth)acryl-based binder and the alkali metal may be included in a weight ratio in a range of about 99:1 to about 60:40, or a weight ratio of 99:1 to 70:30, for example, a weight ratio of 99:1 to 80:20, for example, a weight ratio of 90:10 to 80:20.

In addition, the alkali metal may be included in an amount ranging from about 0.1 mol % to about 1.0 mol % with respect to the total content of the alkali metal and the (meth)acryl-based binder. When the alkali metal is included within the above range, the first layer can have desired or improved adhesion, and a separator including the first layer can exhibit desired or improved heat resistance, air permeability, and oxidation resistance.

The (meth)acryl-based binder may be in various forms, such as an alternating polymer in which the units are alternately distributed, a random polymer in which the units are randomly distributed, or a graft polymer in which some structural units are grafted.

A weight average molecular weight (Mw) of the (meth)acryl-based binder may range from about 200,000 g/mol to about 700,000 g/mol, for example, 200,000 g/mol to 600,000 g/mol, or for example, 300,000 g/mol to 600,000 g/mol. When the weight average molecular weight of the (meth)acryl-based binder satisfies the above range, the (meth)acryl-based binder, and the separator including the (meth)acryl-based binder, can exhibit desired or improved bonding strength, heat resistance, air permeability, and oxidation resistance. The weight average molecular weight may be a polystyrene-converted average molecular weight measured using, e.g., gel permeation chromatography.

A glass transition temperature of the (meth)acryl-based binder may range from about 200° C. to about 280° C., for example, from 210° C. to 270° C., or for example, from 210° C. to 260° C. When the glass transition temperature of the (meth)acryl-based binder satisfies the above range, the (meth)acryl-based binder and the separator including the (meth)acryl-based binder can exhibit desired or improved bonding strength, heat resistance, air permeability, and oxidation resistance. The glass transition temperature may be a value measured by, e.g., differential scanning calorimetry.

The (meth)acryl-based binder may have a melting point Tm of about 160° C. or higher.

The (meth)acryl-based binder may be prepared by, e.g., a solution polymerization method.

According to one example embodiment, the (meth)acryl-based binder may be contained in the first layer of the separator in the form of a film.

### Filler

The filler may be or include an inorganic filler, an organic filler, an organic-inorganic composite filler, or a combination thereof. The inorganic filler may be or include a ceramic material that can increase heat resistance. The inorganic filler may include, for example, at least one of a metal oxide, a metalloid oxide, a metal fluoride, a metal hydroxide, or a combination thereof. The inorganic filler may include, for example, at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof, but is not limited thereto. The organic filler may include at least one of an acrylic compound, an imide compound, an amide compound, or a combination thereof, but is not limited thereto. The organic filler may have a core-shell structure, but is not limited thereto. For example, the filler may be boehmite.

The filler may have a spherical, plate, cubic, or amorphous shape. For example, the filler may have a plate shape.

The filler may be, for example, included in a desired content with respect to the binder. According to one example embodiment, the binder and the filler may be included in a mass ratio in a range of about 1:10 to about 1:50, for example, 1:10 to 1:30 or 1:20 to 1:30. Within the above range, it is possible to reduce the heat shrinkage in the electrolyte.

The filler may have a particle diameter D100 of about 1.0 μm or less. Within the above range, it is possible to readily reach the dry heat shrinkage rate. For example, the filler may have a particle diameter D100 of about 0.8 μm or less, or in a range of about 0.5 μm to 0.6 μm.

The filler may have a particle diameter D50 of about 0.4 μm or less, for example, about 0.3 μm or less, or for example, in a range of about 0.2 μm to about 0.3 μm. Within the above range, it is possible to reduce the heat shrinkage in the electrolyte.

The filler may be contained in an amount in a range of about 50 wt % to about 99 wt %, for example, 70 wt % to 99 wt %, for example, 75 wt % to 99 wt %, for example, 80 wt % to 99 wt %, for example, 85 wt % to 99 wt %, for example, 90 wt % to 99 wt %, or for example, 95 wt % to 99 wt % based on the total amount of the first layer. When the filler is included within the above range, the separator can exhibit desired or improved heat resistance, durability, oxidation resistance, and stability.

The first layer may have a thickness in a range of about 0.01 μm to about 20 μm, and within the above range, have a thickness of 1 μm to 10 μm, 1 μm to 5 μm, or 1 μm to 3 μm.

A ratio of the thickness of the first layer to the thickness of the porous substrate may be in a range of about 0.05 to about 0.5, for example, 0.05 to 0.4, 0.05 to 0.3, or 0.1 to 0.2. Within the above range, the separator can exhibit desired or improved air permeability, heat resistance, bonding strength, and the like. Here, the “thickness of the first layer” is a thickness of one first layer when the first layer is formed on only one surface of the porous substrate, and is a total thickness of two first layers when the first layer is formed on both surfaces of the porous substrate.

### Second Layer

The second layer is an adhesive layer.

The second layer includes a mixture of a PVdF-based adhesive binder and a (meth)acryl-based adhesive binder. The mixture may be included in an amount of about 95 wt % or more of the second layer, for example, in a range of about 95 wt % to about 100 wt %, or 100 wt %.

The PVdF-based adhesive binder may be or include an organic-based adhesive binder. Here, the organic-based adhesive binder is or includes a binder that is soluble in an organic solvent such as, e.g., acetone, or the like.

In an example, the PVdF-based adhesive binder is a PVdF-HFP (hexafluoropropylene) copolymer, and HFP may be included in an amount of about 5 mol % or less of the copolymer, for example 0, 1, 2, 3, 4, 5 mol %. The PVdF-based adhesive binder may have a weight average molecular weight of about 600,000 g/mol to 700,000 g/mol. Within the above range, the effects of the separator can be readily achieved.

The (meth)acryl-based adhesive binder is a copolymer of a monomer mixture including the (meth)acryl-based monomer having a cyano group and the (meth)acryl-based monomer having an alkyl group.

When the (meth)acryl-based monomer having a cyano group does not exist in the monomer mixture, there may be a challenge of reduced adhesion at an aqueous coating (the first layer) of interface.

When the (meth)acryl-based monomer having an alkyl group is not present in the monomer mixture or includes different monomers, there may be a challenge of reduced puncture strength.

According to one example embodiment, the total amount of the (meth)acryl-based monomer having a cyano group and the (meth)acryl-based monomer having an alkyl group may be included in an amount of about 95 mol % or more, for example, a range of about 95 mol % to about 100 mol %, or 100 mol % of the monomer mixture.

The (meth)acryl-based monomer having a cyano group may include one or more of acrylonitrile and methacrylonitrile.

The (meth)acryl-based monomer having an alkyl group may include a (meth)acrylic acid ester having a substituted or unsubstituted linear or branched C1 to C10 alkyl group. For example, the monomer may include one or more of n-butyl (meth)acrylate, sec-butyl (meth)acrylate, tert-butyl (meth)acrylate, n-pentyl (meth)acrylate, n-hexyl (meth)acrylate, n-heptyl (meth)acrylate, n-octyl (meth)acrylate, and 2-ethylhexyl (meth)acrylate as a (meth)acrylic acid ester having a substituted or unsubstituted linear or branched C3 to C8 alkyl group.

The monomer mixture may further include a (meth)acryl-based monomer having a carboxylic acid group. The (meth)acryl-based monomer having a carboxylic acid group has hydrophilicity, thereby increasing adhesion to the first layer, which is an aqueous coating layer.

The (meth)acryl-based monomer having a carboxylic acid group may be (meth)acrylic acid or the like.

The (meth)acryl-based monomer having a carboxylic acid group may be included in an amount in a range of about 0 mol % to about 1 mol %, for example, 0, 0.1, 0.2, 0.3, 0.4, 0.5, 0.6, 0.7, 0.8, 0.9, 1 mol %, 0.3 mol % to 0.8 mol %, or 0.3 mol % to 0.5 mol % of the monomer mixture.

According to one example embodiment, the total amount of the (meth)acryl-based monomer having a cyano group, the (meth)acryl-based monomer having an alkyl group, and the (meth)acryl-based monomer having a carboxylic acid group may be included in an amount of about 95 mol % or more, for example, a range of about 95 mol % to about 100 mol %, or 100 mol % of the monomer mixture.

The (meth)acryl-based adhesive binder may be prepared by polymerizing the monomer mixture through conventional polymerization methods.

The second layer may have a thickness in a range of about 0.01 μm to about 20 μm, and within the above range, have a thickness of 1 μm to 10 μm, 1 μm to 5 μm, or 1 μm to 3 μm.

### Porous Substrate

The porous substrate may be or include a substrate having a plurality of pores and is typically used in electrochemical devices. As a non-limiting example, the porous substrate may be or include a polymer film formed of or including one polymer such as or including at least one of polyolefins such as polyethylene and polypropylene, polyesters such as polyethylene terephthalate and polybutylene terephthalate, polyacetal, polyamide, polyimide, polycarbonate, polyetheretherketone, polyaryletherketone, polyetherimide, polyamideimide, polybenzimidazole, polyethersulfone, polyphenyleneoxide, a cyclic olefin copolymer, polyphenylene sulfide, polyethylenenaphthalate, glass fiber, Teflon, and polytetrafluoroethylene, or a copolymer or mixture of two or more thereof.

The porous substrate may be or include, for example, a polyolefin-based substrate containing a polyolefin, and the polyolefin-based substrate may have a desired or improved shutdown function, thereby contributing to increasing the safety of the battery. The polyolefin-based substrate may be or include at least one of, for example, a polyethylene single film, a polypropylene single film, a polyethylene/polypropylene double film, a polypropylene/polyethylene/polypropylene triple film, and a polyethylene/polypropylene/polyethylene triple film. In addition, the polyolefin-based resin may include a non-olefin resin in addition to an olefin resin or may include a copolymer of olefin and non-olefin monomers.

The porous substrate may have a thickness ranging from about 1 μm to about 40 μm, for example, from 1 μm to 30 μm, from 1 μm to 20 μm, or from 5 μm to 15 μm.

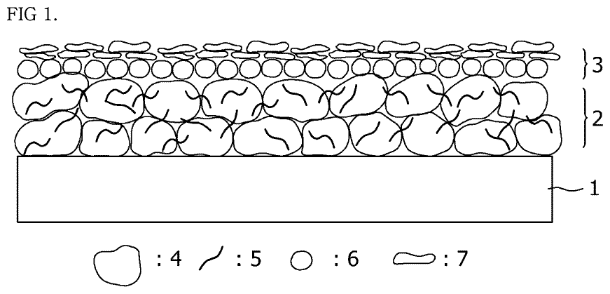

FIG. 1 is a cross-sectional view showing a separator for a rechargeable lithium battery according to one example embodiment.

Referring to FIG. 1, the separator for a rechargeable lithium battery includes a porous substrate 1, and a first layer 2 and a second layer 3 located, e.g., sequentially located, on one surface of the porous substrate 1. The first layer 2 includes a filler 4 and a (meth)acryl-based binder 5. The second layer 3 includes a (meth)acryl-based adhesive binder 6 and a PVdF-based adhesive binder 7.

FIG. 1 illustrates a case in which the first layer 2 and the second layer 3 are stacked on one surface of the porous substrate 1. However, a case in which the first layer 2 and the second layer 3 are stacked on both surfaces of the porous substrate 1 may also be included in the scope of the present disclosure.

### Method of Manufacturing Separator

The separator may be manufactured by operations of preparing a porous substrate, a composition for forming a first layer, and a composition for forming a second layer, manufacturing a coating film for the first layer by coating the porous substrate with the composition for forming the first layer to a predetermined or desired thickness, manufacturing a coating film for a second layer by coating the porous substrate with the composition for forming a second layer to a predetermined or desired thickness, humidifying the coating film for a first layer and the coating film for a second layer, and drying and aging the coating film for a first layer and the coating film for a second layer.

The composition for forming a first layer may include the binder and the filler. The composition may further include an aqueous solvent, for example, water.

The composition for forming a second layer may include the PVdF-based adhesive binder and the (meth)acryl-based adhesive binder, and further include ethanol. Ethanol may cause the PVdF-based adhesive binder to move away from the coating film for a first layer during the humidifying process. The composition may further include an organic solvent, for example, acetone.

The drying may be performed in a drying oven at a temperature in a range of about 40° C. to about 55° C., for example, 50° C., for a duration in a range of about 30 seconds to about 10 minutes, for example, 1 minute. In the above range, the coating film for a first layer and the coating film for a second layer may be dried excessively so that an edge of the separator does not roll or fold, thereby reducing or preventing wrinkles during winding.

The aging may be performed at a high temperature compared to the drying, and for a long time compared to the drying. In this case, the mechanical properties of the separator, such as puncture strength, can be improved by heat-curing the (meth)acryl-based adhesive binder. For example, the aging may be performed at about 40° C. or higher, for example, a range of about 40° C. to about 80° C., for a duration of about 12 hours or longer, for example, a range of about 12 hours to about 24 hours. In the above ranges, the effect of aging can be obtained, and there can be no challenge of peeling due to excessive aging and the second layer becoming a film.

### Rechargeable Lithium Battery

According to one example embodiment, the rechargeable lithium battery includes the separator for a rechargeable lithium battery, a positive electrode, and a negative electrode.

The separator for rechargeable lithium battery refers to the description given above. The separator for rechargeable lithium battery may be located between the positive electrode and the negative electrode.

### Positive Electrode

A positive electrode for a rechargeable lithium battery may include a current collector and a positive electrode active material layer on the current collector. The positive electrode active material layer may include a positive electrode active material, and may further include a binder and/or a conductive material. For example, the positive electrode may further include an additive that can constitute a sacrificial positive electrode.

### Positive Electrode Active Material

The positive electrode active material may include a compound (lithiated intercalation compound) that is capable of intercalating and deintercalating lithium. For example, at least one of a composite oxide of lithium and a metal such as or including at least one of cobalt, manganese, nickel, and combinations thereof may be used.

The composite oxide may be or include a lithium transition metal composite oxide. Examples of the composite oxide may include at least one of lithium nickel-based oxide, lithium cobalt-based oxide, lithium manganese-based oxide, lithium iron phosphate-based compound, cobalt-free lithium nickel-manganese-based oxide, or a combination thereof.

As an example, the following compounds represented by any one of the following Chemical Formulas may be used. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O_{2-α}D_{α} (0.90≤a≤1.8, 0≤b≤0.5, 0≤c≤0.5, and 0<α<2); LiₐNi_{1-b-c}Mn_{b}X_{c}O_{2-α}D_{α} (0.90≤a≤1.8, 0≤b≤0.5, 0≤c≤0.5, and 0<α<2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃(0≤f≤2); or LiₐFePO₄(0.90≤a≤1.8).

In the above Chemical Formulas, A is or includes at least one of Ni, Co, Mn, or a combination thereof, X is or includes at least one of Al, Ni, Co, Mn, Cr, Fe, Mg, Sr, V, a rare earth element or a combination thereof, D is or includes at least one of O, F, S, P, or a combination thereof, G is or includes at least one of Al, Cr, Mn, Fe, Mg, La, Ce, Sr, V, or a combination thereof, and L¹ is or includes at least one of Mn, Al, or a combination thereof.

The positive electrode active material may be or include, for example, a high nickel-based positive electrode active material having a nickel content greater than or equal to about 80 mol %, greater than or equal to about 85 mol %, greater than or equal to about 90 mol %, greater than or equal to about 91 mol %, or greater than or equal to about 94 mol %, and less than or equal to about 99 mol % based on 100 mol % of the metal excluding lithium in the lithium transition metal composite oxide. The high-nickel-based positive electrode active material may be capable of realizing high capacity, and can be applied to a high-capacity, high-density rechargeable lithium battery.

An amount of the positive electrode active material may be in a range of about 90 wt % to about 99.5 wt % based on 100 wt % of the positive electrode active material layer. Amounts of the binder and the conductive material may independently be in a range of about 0.5 wt % to about 5 wt %, respectively, based on 100 wt % of the positive electrode active material layer.

The binder attaches the positive electrode active material particles to each other, and attaches the positive electrode active material to the current collector. Examples of the binder may include at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may impart conductivity (e.g., electrical conductivity) to the electrode. Any material that does not cause a chemical change (e.g., does not cause an undesirable chemical change in the rechargeable lithium battery) and that conducts electrons can be used in the battery. Examples of the conductive material may include a carbon-based material such as or including at least one of natural graphite, artificial graphite, carbon black, acetylene black, ketjen black, a carbon fiber, a carbon nanofiber, and carbon nanotube; a metal-based material containing at least one of copper, nickel, aluminum, silver, and the like, in the form of a metal powder or a metal fiber; a conductive polymer such as a polyphenylene derivative; or a mixture thereof.

Al may be used as the current collector, but the current collector is not limited thereto.

### Negative Electrode

The negative electrode for a rechargeable lithium battery may include a current collector, and a negative electrode active material layer on the current collector. The negative electrode active material layer may include a negative electrode active material, and may further include a binder and/or a conductive material (e.g., an electrically conductive material).

For example, the negative electrode active material layer may include a range of about 90 wt % to about 99 wt % of the negative electrode active material, a range of about 0.5 wt % to about 5 wt % of the binder, and a range of about 0 wt % to about 5 wt % of the conductive material.

### Negative Electrode Active Material

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example, crystalline carbon, amorphous carbon, or a combination thereof. The crystalline carbon may be or include graphite such as non-shaped, sheet-shaped, flake-shaped, sphere-shaped, or fiber-shaped, natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOx (0<x<2), a Si-Q alloy (where Q is or includes at least one of an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include at least one of Sn, SnO₂, a Sn-based alloy, or a combination thereof.

The silicon-carbon composite may be or include a composite of silicon and amorphous carbon. According to an example embodiment, the silicon-carbon composite may be in the form of silicon particles, and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be present between the primary silicon particles, and, for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles, and an amorphous carbon coating layer on a surface of the core.

The Si-based negative electrode active material or the Sn-based negative electrode active material may be used in combination with a carbon-based negative electrode active material.

The binder may attach the negative electrode active material particles to each other, and may attach the negative electrode active material to the current collector. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be or include at least one of a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include at least one of Na, K, or Li.

The dry binder may be or include a polymer material that is capable of being fibrous. For example, the dry binder may be or include at least one of polytetrafluoroethylene, polyvinylidene fluoride, a polyvinylidene fluoride-hexafluoropropylene copolymer, polyethylene oxide, or a combination thereof.

The conductive material may impart conductivity (e.g., electrical conductivity) to the electrode. Any material that does not cause a chemical change (e.g., does not cause an undesirable chemical change in the rechargeable lithium battery) and that conducts electrons can be used in the battery. Non-limiting examples thereof may include a carbon-based material such as or including at least one of natural graphite, artificial graphite, carbon black, acetylene black, ketjen black, a carbon fiber, a carbon nanofiber, and a carbon nanotube; a metal-based material including at least one of copper, nickel, aluminum, silver, and the like, in the form of a metal powder or a metal fiber; a conductive polymer such as a polyphenylene derivative; or a mixture thereof.

The negative current collector may include at least one of a copper foil, a nickel foil, a stainless steel foil, a titanium foil, a nickel foam, a copper foam, a polymer substrate coated with a conductive metal, or a combination thereof.

The rechargeable lithium battery may further include an electrolyte solution.

### Electrolyte Solution

The electrolyte solution for a rechargeable lithium battery may include a non-aqueous organic solvent and a lithium salt.

The non-aqueous organic solvent may constitute a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include ethanol, isopropyl alcohol, and the like. The aprotic solvent may include at least one of nitriles such as R—CN (wherein R is a C2 to C20 linear, branched, or cyclic hydrocarbon group, a double bond, an aromatic ring, or an ether bond, and the like); amides such as dimethylformamide; dioxolanes such as 1,3-dioxolane, 1,4-dioxolane, and the like; sulfolanes, and the like.

The non-aqueous organic solvents may be used alone, or in combination of two or more solvents.

In addition, when using a carbonate-based solvent, a cyclic carbonate and a chain carbonate may be mixed together, and the cyclic carbonate and the chain carbonate may be mixed in a volume ratio in a range of about 1:1 to about 1:9.

The lithium salt dissolved in the organic solvent supplies lithium ions in a battery, enables an operation of a rechargeable lithium battery, and improves transportation of the lithium ions between positive and negative electrodes. Examples of the lithium salt include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y are integers in a range of 1 to 20), lithium trifluoromethane sulfonate, lithium tetrafluoroethanesulfonate, lithium difluoro(oxalato) borate (LiDFOB), lithium difluorobis(oxalato)phosphate (LiDFBOP), and lithium bis(oxalato) borate (LiBOB).

The rechargeable lithium battery may be classified into cylindrical, prismatic, pouch, or coin-type batteries, and the like depending on their shape.

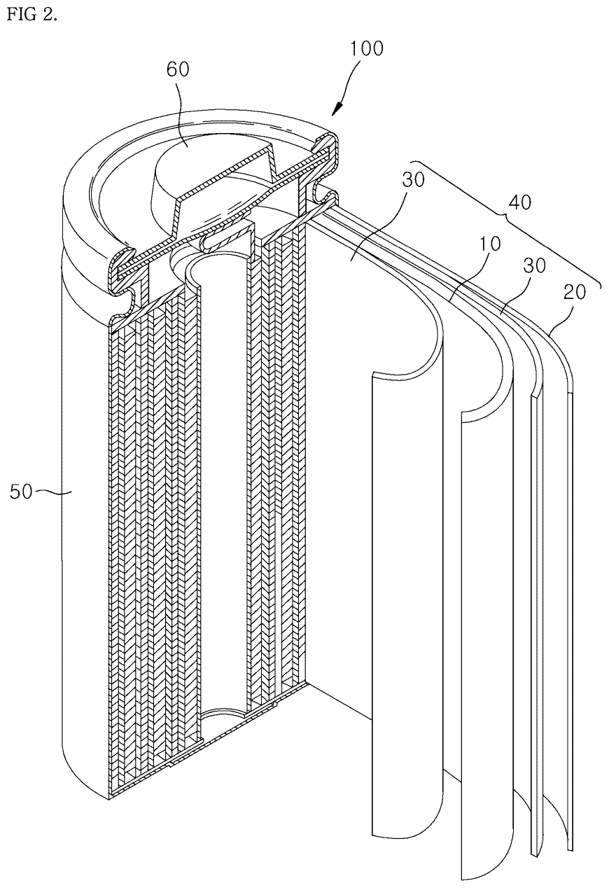

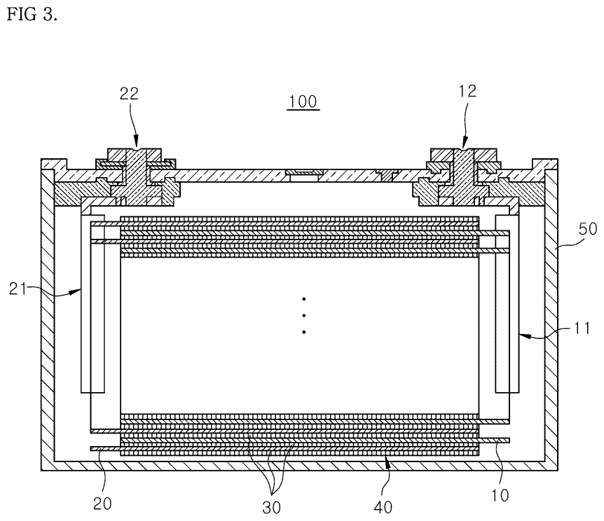

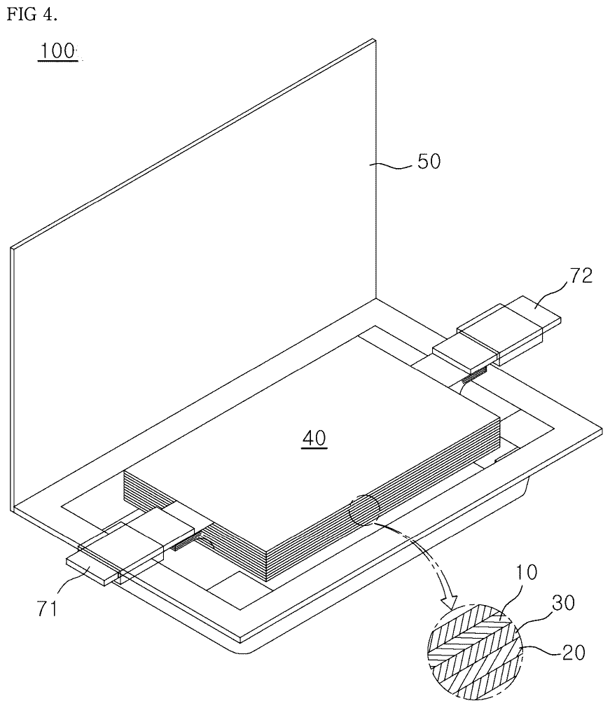

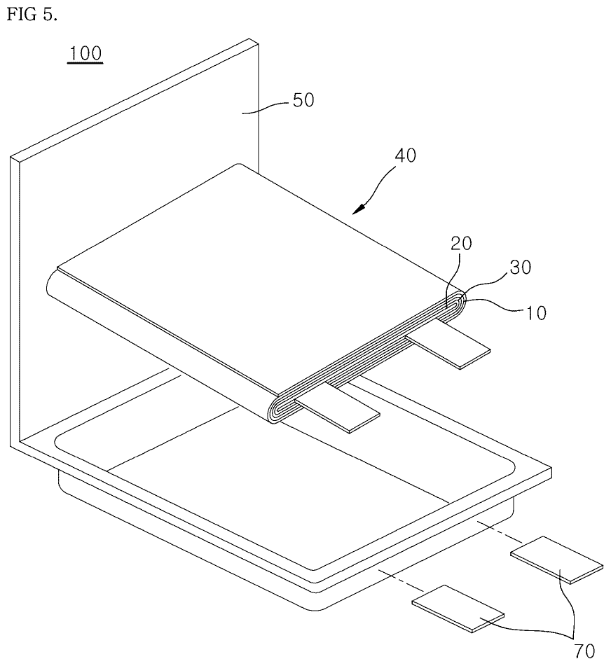

FIG. 2 to FIG. 5 are schematic views illustrating a rechargeable lithium battery according to an example embodiment. FIG. 2 shows a cylindrical battery, FIG. 3 shows a prismatic battery, and FIG. 4 and FIG. 5 show pouch-type batteries. Referring to FIG. 2 to FIG. 5, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution (not shown). The rechargeable lithium battery 100 may include a sealing member 60 sealing the case 50, as shown in FIG. 2. In FIG. 3, the rechargeable lithium battery 100 may include a positive lead tab 11, a positive terminal 12 connected to the positive lead tab 11, a negative lead tab 21, and a negative terminal 22 connected to the negative lead tab 21. As shown in FIG. 4 and FIG. 5, the rechargeable lithium battery 100 may include an electrode tab 70 illustrated in FIG. 5, or, for example, a positive electrode tab 71 and a negative electrode tab 72 illustrated in FIG. 4, the electrode tabs 70/71/72 forming an electric path for inducing the current formed in the electrode assembly 40 to the outside of the battery 100.

The rechargeable lithium battery according to an example embodiment may be applicable to, e.g., automobiles, mobile phones, and/or various types of electric devices, as non-limiting examples.

Hereinafter, examples and comparative examples of the present disclosure is described.

However, the following examples are merely one example embodiment of the present disclosure, and the present disclosure is not limited to the following examples.

### Preparation Example 1

In a 10 L four-necked flask provided with a stirrer, a thermometer, and a cooling tube, a distilled water (6,361 g), acrylic acid (1.0 mol), acrylamide (8.5 mol), potassium persulfate (0.01 mol), 2-acrylamido-2-methylpropanesulfonic acid (0.5 mol), and a 5N aqueous lithium hydroxide solution (1.05 equivalents based on the total amount of 2-acrylamido-2-methylpropanesulfonic acid) were added, then a process of reducing an internal pressure to 10 mmHg using a diaphragm pump, and returning the internal pressure to a normal pressure using nitrogen was repeated three times.

The reaction was carried out for 12 hours while controlling the temperature of the reaction solution to be stable between 65° C. and 70° C. After cooling to room temperature, the pH of the reaction solution was adjusted to a range of 7 to 8 using a 25% aqueous ammonia solution.

In this way, poly(acrylic acid-co-acrylamide-co-2-acrylamido-2-methylpropanesulfonic acid) lithium salt was prepared. Here, a molar ratio of the structural unit derived from acrylic acid, the structural unit derived from acrylamide, and the structural unit derived from 2-acrylamido-2-methylpropanesulfonic acid was 10:85:5. A non-volatile component in about 10 mL of the reaction solution (reaction product) was measured and the measurement result was 9.5 wt % (theoretical value: 10 wt %).

### Preparation Example 2

A binder was manufactured by the same method as in Preparation Example 1, except that the molar ratio of the structural unit derived from acrylamide and the structural unit derived from 2-acrylamido-2-methylpropanesulfonic acid was 85:15.

### Example 1

### Preparation of Composition for a Second Layer

As a PVdF-based adhesive binder, a PVdF-HFP (Mw of 600,000 g/mol and 5 mol % or less of HFP) adhesive binder was prepared.

As a (meth)acryl-based adhesive binder, a copolymer (binder 1) of a monomer mixture containing 10 mol % of acrylonitrile, 50 mol % of n-butyl acrylate, and 40 mol % of n-butyl methacrylate was prepared. The binder 1 was an amorphous heat curable binder having a weight average molecular weight of 1.2 million g/mol and a glass transition temperature of −20° C.

A composition for a second layer was prepared by mixing 1 part by weight of the (meth)acryl-based adhesive binder and 15 parts by weight of the PVdF-based adhesive binder in 100 ml of acetone and adding 5 ml of ethanol.

### Manufacturing of Separator

A composition for forming a first layer was prepared by mixing the acryl-based binder (10 wt % in distilled water) prepared in Preparation Example 1 and boehmite (particle diameter D100: 0.5 μm, particle diameter D50: 0.2 μm, a plate shape), adding the mixture to a water solvent, milling and dispersing the mixture at 25° C. for 30 minutes using a bead mill, and adding water so that the total solid content was 20 wt %.

Among the composition for forming a first layer, the acryl-based binder of Preparation Example 1 and boehmite are included in a mass ratio of 1:20.

A coating film for a first layer was manufactured by coating both surfaces of a porous substrate of a polyethylene-based film (thickness: 5.5 μm, SK company, air permeability: 100 sec/100 cc, puncture strength: 280 kgf) with the composition for forming a first layer using a die-coating method to a thickness of 1.0 μm.

A separator was manufactured by manufacturing a coating film for a second layer by coating the coating film for a first layer with the composition for forming a second layer to a thickness of 0.5 μm, treating the coating film with steam at 90° C. for 1 hour in a closed space, drying the coating film for a second layer at 50° C. for 1 minute, and aging the coating film for a second layer at 40° C. for 12 hours.

### Example 2

A separator was manufactured by the same method as in Example 1, except that the coating film for a second layer was aged at 60° C. for 12 hours in Example 1.

### Example 3

A separator was manufactured by the same method as in Example 1, except that the coating film for a second layer was aged at 80° C. for 12 hours in Example 1.

### Example 4

A separator was manufactured by the same method as in Example 1, except that 1 part by weight of the (meth)acryl-based adhesive binder and 20 parts by weight of the PVdF-based adhesive binder were mixed in Example 1.

### Example 5

A separator was manufactured by the same method as in Example 1, except that a copolymer (binder 2) of a monomer mixture containing 20 mol % of acrylonitrile, 40 mol % of n-butyl acrylate, and 40 mol % of n-butyl methacrylate was used as the (meth)acryl-based adhesive binder in Example 1.

### Example 6

A separator was manufactured by the same method as in Example 1, except that the binder of Preparation Example 2 was used instead of the binder of Preparation Example 1 in Example 1.

### Comparative Example 1

A separator was manufactured by the same method as in Example 1, except that only a PVdF-based adhesive binder was included in the composition for a second layer in Example 1.

### Comparative Example 2

A separator was manufactured by the same method as in Example 1, except that only a (meth)acryl-based adhesive binder was included in the composition for a second layer in Example 1.

### Comparative Example 3

A separator was manufactured by the same method as in Example 1, except that a copolymer (binder 3) of a monomer mixture containing 50 mol % of n-butyl acrylate and 50 mol % of n-butyl methacrylate was used as the (meth)acryl-based adhesive binder in Example 1.

### Comparative Example 4

A separator was manufactured by the same method as in Example 1, except that polyacrylonitrile (binder 4) was used as a (meth)acryl-based adhesive binder in Example 1.

The following physical properties were evaluated for the separators manufactured in the examples and the comparative examples.

Air permeability (unit: sec/100 cc)

The air permeability was measured by a method of measuring the time (units: seconds) it took for 100 cc of air to pass through the separator using a measurement device (EG01-55-1MR, Asahi Seiko).

Air permeability measurement device setting conditions:

Measurement pressure: 0.5 kg/cm², cylinder pressure: 2.5 kg/cm², set time: 5 seconds.

### Puncture Strength (Units: Gf)

Each of the separators manufactured in the examples and the comparative examples was cut at 10 different points with a width (for example, the machine direction, MD) of 50 mm and a length (for example, the transverse direction, TD) of 50 mm to produce 10 samples, the samples were placed on a 10 cm hole using GATO Tech G5 equipment, and then the puncture force was measured while pressing the samples with a 1 mm probe. The puncture strength of each sample was measured three times, and then an average value was calculated.

### Dry Heat Shrinkage Rate (Units: %)

Samples were manufactured by cutting the separators for a rechargeable lithium battery of the examples and the comparative examples to a size of 10 cm×10 cm. A heat shrinkage rate in each of the machine direction (MD) and the transverse direction (TD) was calculated by leaving the sample in the oven at 150° C. for 1 hour and then measuring dimensions of sides of the quadrangle of the sample. The heat shrinkage rate was calculated according to the following Equation 1.

$$Heat shrinkage rate = ( L 0 - L 1 ) / L 0 \times 10 \; 0 . \qquad Equation 1$$

L0 denotes an initial length of the separator, and L1 denotes a length of the separator after being left at 150° C. for 1 hour.

### Substrate Adhesion (Units: N/12 mm)

The separator was cut to a width of 12 mm and a length of 50 mm to produce a sample. Tape was attached to a surface of the second layer of the sample, and the surface to which the tape was adhered and the substrate were separated by about 10 to 20 mm, the substrate side to which the tape was not adhered was then fixed to an upper grip, the second layer side to which the tape was adhered was fixed to a lower grip with a gap of 20 mm between the grips, and then peeling was performed by pulling in a 180° direction. In this case, a peeling speed was set to 10 mm/min, and an average value of forces required to peel 40 mm after the start of peeling was obtained by measuring three times.

TABLE 1

| | | Second layer | | | | | | | |
|---|---|---|---|---|---|---|---|---|---|
| | | PVdF- | (Meth)acryl- | | | | Heat | | |
| | | based | based | | | | shrinkage | | |
| | Binder of | adhesive | adhesive | Mass | Air | Puncture | rate | | Substrate |
| | first layer | binder | binder | ratio | permeability | Strength | MD | TD | Adhesion |
| Example 1 | Preparation | Included | Binder 1 | 1:15 | 149 | 342 | 3.2 | 0.8 | 1.3 |
| | Example 1 | | | | | | | | |
| Example 2 | Preparation | Included | Binder 1 | 1:15 | 152 | 360 | 2.7 | 0.7 | 1.4 |
| | Example 1 | | | | | | | | |
| Example 3 | Preparation | Included | Binder 1 | 1:15 | 155 | 356 | 2.8 | 0.8 | 1.2 |
| | Example 1 | | | | | | | | |
| Example 4 | Preparation | Included | Binder 1 | 1:20 | 171 | 361 | 3.1 | 0.9 | 1.0 |
| | Example 1 | | | | | | | | |
| Example 5 | Preparation | Included | Binder 2 | 1:15 | 159 | 347 | 2.8 | 1.0 | 1.4 |
| | Example 1 | | | | | | | | |
| Example 6 | Preparation | Included | Binder 1 | 1:15 | 148 | 342 | 3.0 | 1.2 | 1.2 |
| | Example 2 | | | | | | | | |
| Comparative | Preparation | Included | Not | — | 138 | 297 | 4.5 | 1.8 | 0.2 |
| Example 1 | Example 1 | | included | | | | | | |
| Comparative | Preparation | Not | Binder 1 | — | 131 | 326 | 3.6 | 1.3 | 0.7 |
| Example 2 | Example 1 | included | | | | | | | |
| Comparative | Preparation | Included | Binder 3 | 1:15 | 152 | 332 | 3.7 | 1.5 | 0.5 |
| Example 3 | Example 1 | | | | | | | | |
| Comparative | Preparation | Included | Binder 4 | 1:15 | 158 | 335 | 4.0 | 1.9 | 0.6 |
| Example 4 | Example 1 | | | | | | | | |

* mass ratio: mass ratio of (meth)acryl-based adhesive binder: PVdF-based adhesive binder

As shown in Table 1, the separators for a rechargeable lithium battery of the examples can provide high substrate adhesion, a low heat shrinkage rate, and high puncture strength, thereby increasing the life and stability of the battery.

However, the separators of the comparative examples, which cannot satisfy all of the configurations of the second layers of the examples, do not have high substrate adhesion and have high heat shrinkage rates.

The separator for a rechargeable lithium battery according to one example embodiment has high substrate adhesion, a low heat shrinkage rate, and a high puncture strength, thereby increasing the stability and lifetime of the battery.

Although example embodiments of the present disclosure have been described above, the present disclosure is not limited thereto and may be modified in any form within the scope of the claims, the detailed description of the present disclosure, and the accompanying drawings, and the modifications also fall within the scope of the present disclosure.

What is claimed is:

1. A separator for a rechargeable lithium battery, the separator comprising:
a porous substrate; and
a first layer and a second layer located on at least one surface of the porous substrate,
wherein the second layer comprises a mixture of a polyvinylidene fluoride (PVdF)-based adhesive binder and a (meth)acryl-based adhesive binder, and
the (meth)acryl-based adhesive binder comprises a copolymer of a monomer mixture including a (meth)acryl-based monomer having a cyano group and a (meth)acryl-based monomer having an alkyl group.

2. The separator of claim 1, wherein the (meth)acryl-based adhesive binder comprises an amorphous binder.

3. The separator of claim 1, wherein the (meth)acryl-based adhesive binder comprises a thermosetting binder.

4. The separator of claim 1, wherein the (meth)acryl-based adhesive binder has a weight average molecular weight in a range of about 1 million g/mol to about 1.5 million g/mol.

5. The separator of claim 1, wherein the (meth)acryl-based adhesive binder has a glass transition temperature in a range of about −20 to about −10° C.

6. The separator of claim 1, wherein the (meth)acryl-based adhesive binder comprises a copolymer of a monomer mixture containing a range of about 1 mol % to about 20 mol % of the (meth)acryl-based monomer having a cyano group and a range of about 80 mol % to about 99 mol % of the (meth)acryl-based monomer having an alkyl group.

7. The separator of claim 1, wherein, in the second layer, a weight ratio of the (meth)acryl-based adhesive binder and the PVdF-based adhesive binder is in a range of about 1:10 to about 1:30.

8. The separator of claim 1, wherein the (meth)acryl-based adhesive binder comprises a copolymer of a monomer mixture including (meth)acrylonitrile, n-butyl acrylate, and n-butyl methacrylate.

9. The separator of claim 1, wherein the monomer mixture further comprises a (meth)acryl-based monomer having a carboxylic acid group.

10. The separator of claim 1, wherein the PVdF-based adhesive binder comprises an organic adhesive binder.

11. The separator of claim 1, wherein the PVdF-based adhesive binder comprises a PVdF-hexafluoropropylene (HFP) copolymer having about 5 mol % or less of HFP.

12. The separator of claim 1, wherein:
the first layer comprises a binder and a filler, and
the binder comprises an aqueous binder.

13. The separator of claim 12, wherein the binder comprises a (meth)acryl-based binder containing a sulfonate group-containing structural unit.

14. The separator of claim 12, wherein the filler has a particle diameter D100 of about 1.0 μm or less.

15. The separator of claim 12, wherein the binder and the filler are included in a mass ratio in a range of about 1:10 to about 1:50.

16. A rechargeable lithium battery comprising:
the separator for a rechargeable lithium battery of claim 1;
a positive electrode; and
a negative electrode.
